(19) United States
(12) Patent Application Publication
(10) Pub. No.: US 2007/0240383 A1
(43) Pub. Date: Oct. 18, 2007

(54) Container Welding Method

(76) Inventors: Gerhard Keller, Vouvry (CH); Hugues-Vincent Roy, Vouvry (CH); Jacques Thomasset, Vouvry (CH)

Correspondence Address: NIXON & VANDERHYE, PC, 901 NORTH GLEBE ROAD, 11TH FLOOR, ARLINGTON, VA, 22203, US

(21) Appl. No.: 11/596,191

(22) PCT Filed: Apr. 18, 2005
(86) PCT No.: PCT/IB05/51254

§ 371 Date: Nov. 13, 2006

(30) Foreign Application Priority Data
May 13, 2004 (CH) CH 00843/04

(51) Int. Cl. B29C 65/02

(52) U.S. Cl. 53/373.7

(57) ABSTRACT

The invention relates to a method for manufacturing a plastic container, comprising the edge-clamping of a flat, flexible piece forming a curved surface over the inner face of a hollow body, characterized in that the following steps are performed: the edge of the piece is placed in contact with the inner face of the hollow body; a thrust or tensile force is applied to the piece in a direction perpendicular to its surface such as to induce in the piece radial forces resulting in a bringing-together of the edge of the piece against the inner face of the hollow body.

### FIELD OF THE INVENTION

The present invention relates to a method for manufacturing containers that makes it possible to weld a semirigid plastic piece having a slightly concave form to an end of a hollow plastic body.

The present invention is intended in particular, but not exclusively, for the field of packaging for non-carbonated food-grade beverages, such as fruit juices, vitamin drinks, milk, iced tea, etc.

Another field of application of the present invention is that of flexible plastic tube for packaging viscous products, such as toothpaste, body-care crèmes, pharmaceutical ointments, food products (mayonnaise, ketchup, mustard), etc.

A third area of application of the present invention is that of cartridges for technical products, such as silicone or mastic.

### Prior Art

The production of containers provided with a semirigid piece sealed to a hollow plastic body of principally cylindrical form is a technology frequently used in the manufacture of packaging.

An example of this application is the manufacture of flexible tube in which the product is extracted by finger pressure on the walls of the tube. A container of this type is produced by sealing a semirigid head to one of the ends of a cylindrical hollow body, commonly known as the skirt. In this field of flexible tube, there are skirts produced from mono- or multi-layer sheets rolled and welded in their longitudinal direction, and also skirts obtained by extrusion (or coextrusion, in the case of multi-layer tube) of hollow bodies. The tube head is produced separately by injection molding. The tube head is sealed with the aid of a mandrel, allowing the skirt and the head to be held in place. There is copious literature relating to the production of flexible tube: the Delavy & Keller patent (DE 4216889) gives a good overview of the prior art.

Another area of application of this technology is the production of straight flexible pouches with a semirigid piece at one of their ends. An example of such packaging is given in the Spiess & Sohn patent (AU 293944), in which a semirigid head is welded to a flexible sheet shaped as cylindrical tube so as to manufacture a straight flexible pouch. Michalsky (EP 1362797) also discloses relatively similar packaging, in which the body of the container can have semirigid pieces attached to its two ends.

From the technical standpoint, in order to produce such articles it is necessary to seal a semirigid piece on one end of a cylindrical body. To produce a quality weld between the tube and the attached piece the area to be welded must be subjected to the following conditions: the area must be exposed to the welding temperature of the plastic while a certain pressure is exerted on the area for a certain period of time. There are different ways in which to provide the heat for welding the pieces: hot-air heating, induction heating, IR heating, friction or ultrasound heating. In all these methods, a force has to be exerted, uniformly distributed over the periphery of the tube at the height of the piece to be sealed. The mechanical means for exerting such a force or pressure on the periphery of the tube are complex, prevent or disrupt the transfer of heat, and leave traces of parting lines on the product. This is commonly performed with the aid of an internal mandrel that exerts the necessary radial force for sealing. The use of a mandrel of this type and the welding or manufacturing methods are well known in the field of flexible-tube production (FIG. 1; piece 2). In a very similar manner, it is also possible to weld a piece to form the base of a tube (FIG. 2; piece 15). However, it is much less obvious to seal an end to tube whose other end is partially or totally closed, as it is no longer possible to use the internal mandrel. Such examples are presented in FIG. 1 (sealing of a base 15 on tube with a head 2), FIG. 2 (sealing of a head 2 on tube having a base 15) or FIG. 3 (sealing of an intermediate piece 16 and a base 15 on tube with a head 2).

### SUMMARY OF THE INVENTION

An object of the present invention is to propose a method for manufacturing flexible containers that makes it possible to seal a plastic piece having a slightly concave form to an end of a hollow plastic body without using a mandrel inside the hollow body. The method according to the invention proposes a very simple way in which to generate the pressure needed for welding without the use of an internal mandrel.

The present invention thus makes it possible to manufacture articles such as in FIGS. 1, 2 and 3, thereby solving the abovementioned problem.

For simplification's sake, but not exhaustively, the description and the examples given below will be restricted to the case of welding heads and bases on tube made from laminated material containing a thin aluminum sheet. This aluminum sheet inside the structure of the layers of the composite material confers excellent barrier properties on the packaging and at the same time allows the use of HF heating technology, which is very effective and elegant. This tube is produced from a multi-layer flat sheet or strip containing at least one aluminum layer and including a longitudinal lap weld. Induction heating is also used for welding the head or base. The absence of mechanical means for producing the bearing force and the welding pressure renders the application of induction-welding technology particularly suitable, since the HF inductor can be placed very close to the area to be welded, eliminating the problem of shielding the mechanical piece.

The method according to the invention is based on the fact that the pressure needed for welding the head or the semirigid base to the skirt is obtained by the temporary or permanent deformation of the semirigid piece. By deforming this piece in a controlled manner, it is possible to increase its diameter and thus the piece rests on the skirt and on a welding tool placed on the outside of the skirt. It is thus possible to produce uniform pressure over the entire area to be sealed.

### DESCRIPTION OF THE FIGURES

FIG. 1 shows a container comprising a skirt 1, a convex head 2 and a concave base 15.

FIG. 2 shows a container that comprises a skirt 1, a concave head 2 and a convex base 15.

FIG. 3 shows a container that comprises a skirt 1, a convex head 2, an intermediate piece 15 and a concave base 14.

FIGS. 4a and 4b show the device according to the invention in the case of the welding of a head 2 to a skirt 1. The skirt 1 and the head 2 are positioned with the aid of a welding tool 10 that comprises an HF welding coil 11. The end of the skirt 2 and of the head 6 rests on a support area of the tool 6 that is perpendicular to the direction Z. The head is subjected to a tensile force in the direction Z with the aid of a connecting rod 8 that includes an internal thread 9 screwed onto the thread 7 of the neck of the head 3.

FIG. 4a shows the head 2 in the initial state. In FIG. 4b, the head 2 is deformed through the effect of the tensile force imparted by the rod 8. Deformation of the head 2 generates a radial force that directs the periphery of the head 5 toward the inner face of the skirt 1.

FIGS. 5a and 5b show the device according to the invention in the case of the welding of a head 2 inside a skirt 1. The skirt 1 is positioned with the aid of a welding tool 10 located on its outer periphery and comprising an HF welding coil 11. The head 6 rests in its concave part 4 on an annular support piece 14. The head is subjected to a tensile force in the direction Z with the aid of a connecting rod 8 that includes an internal thread 9 screwed onto the thread 7 of the neck of the head 3. FIG. 5a shows the head 2 in the initial state. In FIG. 5b, the head 2 is deformed through the effect of the tensile force imparted by the rod 8. Deformation of the head 2 generates a radial force that directs the periphery of the head 5 toward the inner face of the skirt 1.

FIG. 6 shows the device according to the invention in the case of the welding of a head 2 to a skirt 1 while the other end of the hollow body is only partially closed. The skirt 1 and the head 2 are positioned with the aid of a welding tool 10 that comprises an HF welding coil 11. The end of the skirt 2 and of the head 6 rests on a support area of the tool 6 that is perpendicular to the direction Z. The head is subjected to a thrust in its central part 16 in the direction Z with the aid of a push rod 15.

### DETAILED DESCRIPTION

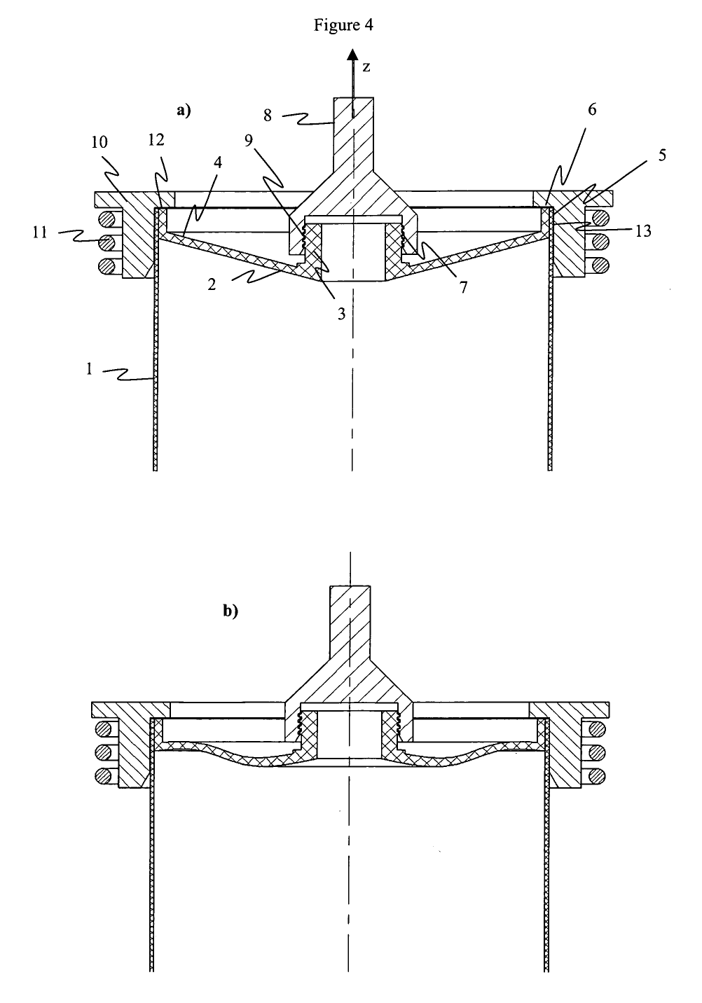

The principle of the method according to the invention is clearly explained by means of a definition of the various steps in the method, presented in FIGS. 4a and 4b :

1) The tube skirt 1 and the head have to be positioned precisely inside a welding tool 10, as shown in FIG. 4a. This welding tool 10 has to cover the area to be sealed and also guide the skirt 2. This tool includes a perpendicular area 12 allowing the skirt 1 and the head 2 to rest thereon in the direction Z.

2) A connecting rod 8 is attached to the neck of the head 3. The two pieces may be held in different ways, for example by screwing an internal thread 9 on the thread of the neck 7.

3) A tensile force is exerted by the rod 8 on the head 2 in the direction Z. As the head is held in place by the welding tool 10 in the support area 12, the result is that the head 2 will be deformed, as shown in FIG. 4b, owing to its slightly concave shape, if it is made from semirigid material. Deformation of the head 2 generates a slight sliding of the end of the head 6 on the support 12 toward the outside, and thus an increase in the diameter of the head. The area to be welded of the head 5 thus rests with greater force and also uniformly against the wall of the tube 2 and against the radial support area of the tool 13. It is thus possible to apply pressure to the two pieces to be sealed.

4) Welding is performed by means of local heating of the skirt with the aid of the induction coil 11.

5) After welding, the connecting rod 8 is detached from the head 2. By eliminating the tensile force, the head resumes its initial geometry by virtue of the elastic properties of the plastic. It is thus easy to expel the article obtained (skirt with welded piece) from the welding tool 10.

These various operations are performed with the aid of mechanical pieces and/or with the aid of an increase or reduction in pressure inside or outside the container.

A particularly advantageous aspect of the present invention is that this method is not restricted to the sealing of a tube head having an opening at their center, but may also be applied to a closed piece, such as a tube base.

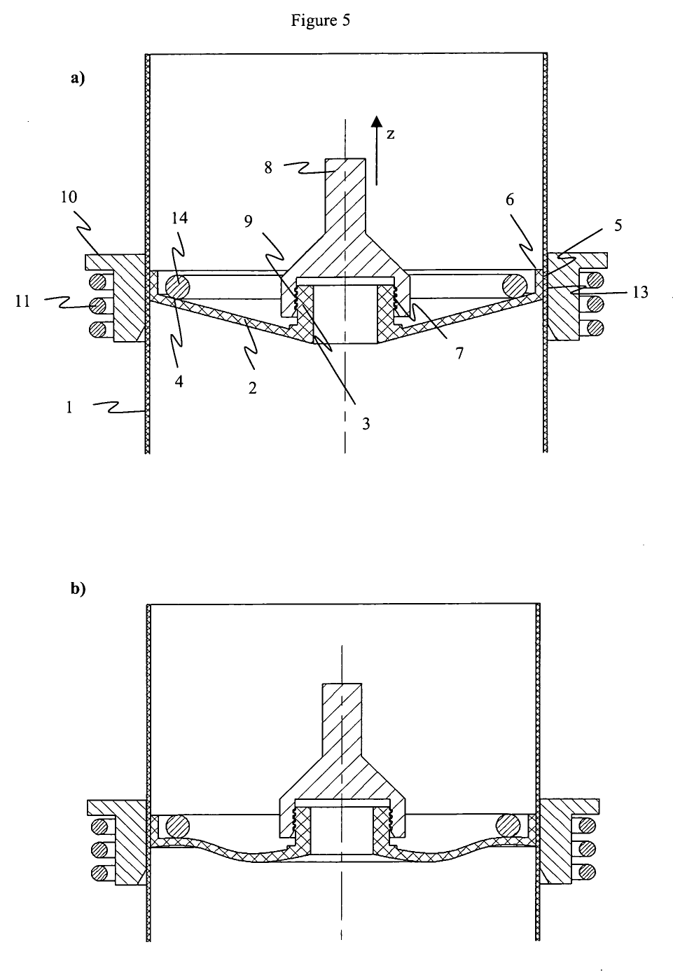

Another particularly advantageous aspect of the present invention is that this method is not restricted to the sealing of pieces to the ends of a skirt, but may also be applied at any location along the skirt (even FIG. 3). By way of example, but not exhaustively, the use of intermediate pieces makes it possible to compartmentalize or stiffen the container. FIGS. 5a and 5b show the case of the welding of a head 2 at a location of the skirt 1 that is not an end. In this case, the welding tool 10 is a cylinder surrounding the skirt. The head 2 is held in position with the aid of a support 14 positioned in the concave part of the head 4 (FIG. 5a). While the tensile force is exerted by the rod 8, the head 2 is deformed, as shown in FIG. 5b, and its end 6 is displaced toward the outside owing to the slight rotation of the head on the support 14. Thus, the area of the head 5 to be welded exerts a radial pressure on the skirt and on the support area of the welding tool 13. Welding by means of local HF heating of the skirt is identical to that described above.

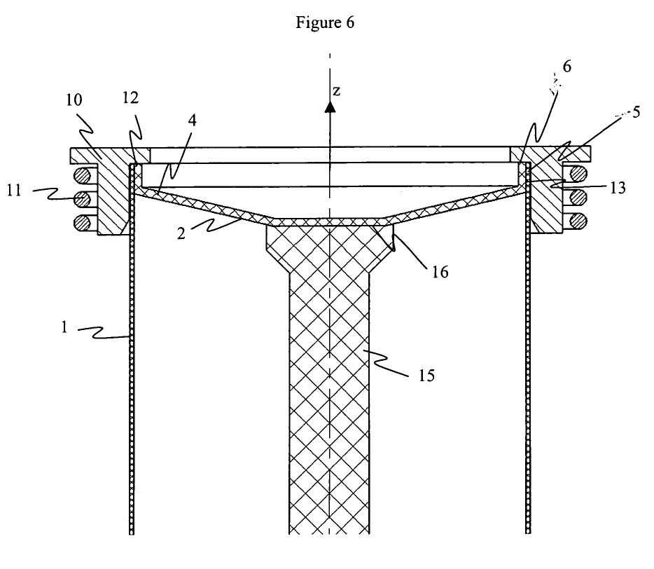

According to another manufacturing method of the present invention, in the case of hollow bodies only partially closed at one end, it is also possible to weld slightly concave pieces on the other end of the hollow body by applying a thrust force to the central part of the inner face of said piece (see FIG. 6). In this case, the application of a thrust force to its inner face makes it possible to deform the piece so as to increase its apparent diameter, thereby creating the pressure necessary for welding said piece to the hollow body.

Another particularly advantageous aspect of the present invention is that this method is not restricted to cylindrical containers, but makes it possible to weld plastic pieces to flexible hollow bodies having cross sections of various convex forms. By way of example, but not exhaustively, mention may be made of containers having a cross section in the form of an oval or of a polygon (square, pentagon, hexagon, etc.) with rounded angles.

It should be noted that deformation of the head 2 may be permanent, and thus it is possible to obtain a head with a final form that is different from its initial form. This is possible in the case of a highly concave piece that is able to “turn back” around this concave area 4. The result of this is that the height of the neck 3 relative to the end 6 is different in the initial state and in the final state.

According to another manufacturing method of the present invention, it is possible to weld domed (concave or convex) pieces to the inner face of the free end of a hollow plastic body. In this case, the application of a tensile force to its central part makes it possible to deform the piece so as to reduce its apparent diameter and thus position it inside a hollow body having a diameter equal to the external diameter of the piece in its initial state. Once positioned, the tensile force is eliminated, which makes it possible for the piece to resume its initial form, thereby pressing the periphery of the piece against the inner wall of the hollow body. By adjusting the external diameter of the piece and the internal diameter of the hollow body, it is possible to control the pressure force exerted on the welding area between the two articles. Welding is then performed with the aid of HF heating, as described above.

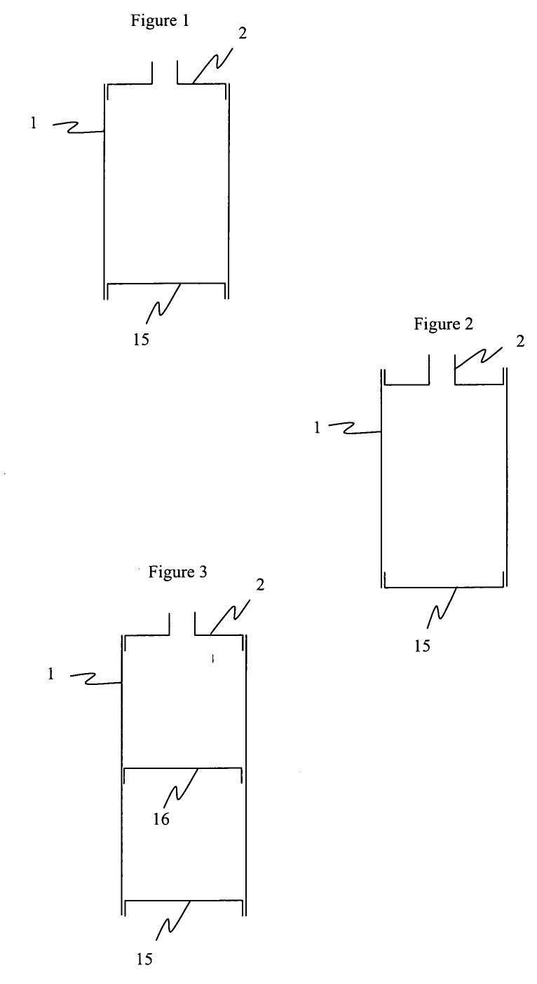

According to the present invention, it is possible to obtain containers that have the special feature of a head and base that include radial welds with the cylindrical body forming the container. These welds are distinguished by the fact that they are located totally inside the cylindrical body. Furthermore, these containers have a head and a base that do not include any area of contact with the cylindrical body located outside the cylindrical body. FIGS. 1 and 2 show containers of this type according to the invention.

1. A method for manufacturing a plastic container, comprising the edge-clamping of a flat, flexible piece (2) over the inner face of a hollow body (1), said piece (2) having a concave face and a convex face,
characterized in that the following steps are performed:
the edge of the piece (2) is placed in contact with the inner face of the hollow body (1);
a thrust or tensile force is applied to the central part (3) of the piece (2) in a direction (z) perpendicular to its surface such as to induce in the piece (2) radial forces resulting in a bringing-together of the edge of the piece (2) against the inner face of the hollow body (1).

2. The method as claimed in claim 1, characterized in that said radial forces are permanently induced.

3. The method as claimed in claim 1, characterized in that said radial forces are temporarily induced at the time of the clamping of the piece (2) on said inner face.

4. The method as claimed in claim 1, characterized in that said thrust or tensile force is applied to the concave face of said piece (2).

5. The method as claimed in claim 1, characterized in that said thrust or tensile force is applied to the convex face of said piece (2).

6. The method as claimed in claim 1, characterized in that a tensile force is applied to the central part (3) of said piece (3) while said piece (2) is held in position with the aid of a backing piece (13) resting solely on the slightly concave area of said piece (2) or on the outside of said area.

7. The method as claimed in claim 1, characterized in that a thrust force is applied to the central part (3) of said piece (2) while holding the latter in position with the aid of a backing piece (13).

8. The method as claimed in claim 1, characterized in that:
when said piece (2) is positioned in said hollow body (1) and when welding takes place, said piece (2) is held solely on its outer face;
when said piece (2) is positioned in said hollow body (1), a radial force is applied that deforms said piece (2) and directs the periphery of said piece (2) toward the inside so that it is possible to insert it in said hollow body (1);
at the time of the welding operation, the radial force is removed, which enables said piece (2) to resume its initial form and, at the periphery of said piece (2), to exert a pressure on the inner face of said hollow body (1).

9. The method as claimed in claim 8, characterized in that said thrust or tensile force is applied from the inside of the hollow body (1).

10. The method as claimed in claim 1, comprising a step in which the concave face of said piece (2) is deformed in order to render it convex, and vice versa.

11. A device for manufacturing a plastic container consisting of a hollow body (1) and at least one flexible, flat piece (2) forming a curved surface, the edge of which is clamped on the inner face of said hollow body (1), characterized in that it comprises means (8) for applying a thrust or tensile force on the central part (3) of said piece (2) in a direction perpendicular to its surface such as to induce radial forces directed toward the edge of the piece (2).

12. The device as claimed in claim 11, characterized in that said means (8) for applying a thrust or tensile force are adapted in order to generate a tensile force on the central part (3) of the outer face of said piece (2).

13. The device as claimed in claim 11, characterized in that it comprises means for radially compressing said piece (2) and in that said means for applying a thrust or tensile force consist of the return force induced by the return of the piece (2) to its initial form.
